(19) United States
(12) Patent Application Publication
(10) Pub. No.: US 2003/0234512 A1
(43) Pub. Date: Dec. 25, 2003

(54) Trailer hitch video alignment system

(76) Inventor: David G. Holub, Cologne, MN (US)

Correspondence Address: HOFFMAN, WASSON & GITLER, PC, Suite 522, 2361 Jefferson Davis Highway, Arlington, VA, 22202, US

(21) Appl. No.: 10/175,279

(22) Filed: Jun. 20, 2002

(51) Int. Cl. B62D 53/06

(52) U.S. Cl. 280/432

(57) ABSTRACT

The battery-powered trailer hitch video alignment system is wireless, having a video camera and transmitter relaying images of the trailer hitch to a monitor by the driver. The camera is mounted either on the towing vehicle or the trailer, whichever gives the best view of the alignment-between the trailer hitch and trailer. An infrared light arrangement provides light for the camera in low-light or no-light conditions. Also, the infrared light incorporates a tape measure in the lighting system to transmit distance measurements between the towed vehicle and trailer. In this regard the infrared system provides both light and distance measurements for the benefit of the operator.

### FIELD OF THE INVENTION

The invention relates to devices for facilitating the connection between a vehicle and a towed trailer.

### BACKGROUND OF THE INVENTION

Vehicles are often used to tow trailers, such as campers or boat trailers. A hitch mounted to the back of the vehicle engages and is locked to the trailer. The hitch is centered on the vehicle and mounted low so as to be out of the view of the driver. The driver must maneuver the vehicle to line the hitch with the trailer to couple the vehicle to the trailer. This often requires the use of a second person to guide the driver in maneuvering the vehicle to align the hitch and trailer.

U.S. Pat. No. 5,452,982 (Engle) discloses a system for positioning trailers of trucks on railroad cars. A stanchion is mounted on the railroad car to support the trailer and secured to the railroad car. An operator within the cabin of a tractor can monitor the relationship between the tractor, trailer, stanchion and actuated on the tractor which interacts with the stanchion to position the stanchion. A television camera is mounted to the frame of the tractor to transmit a view of the coupling to a TV monitor viewed by the driver.

U.S. Pat. No. 5,191,328 (Nelson), discloses a trailer hitching aid. A transmitter 20 is mounted on the forward end of a trailer. The transmitter provides two signals: one infrared, and one, ultrasonic, that cooperate with receivers on the back of the towed vehicle to provide alignment information to the driver. The driver views an inverted ‘T’ on the display screen of the computer. When the hitch components are in vertical registry, a single, darkened spot appears at the intersection of the vertical and horizontal legs of the ‘T’ to indicate that alignment is complete.

U.S. Pat. No. 5,215,423 (Schulte-Hinsken et al) discloses a system for determining the spatial position of one object, such as a trash can, so that it may be picked up by a tipping mechanism. A camera and light projector are provided in the garbage-collecting truck and retroreflecting markings on the trash can reflect light from the light projector and received by the camera. A computer relays the information to a monitor mounted on the instrument panel of the truck to enable the driver to activate means for picking up the can.

There is a need in prior art for a system for providing a driver with real-time images, between a trailer hitch and trailer, to facilitate alignment.

It is the object of the invention to provide a system for facilitating the alignment between a trailer hitch and trailer.

It is another object of the invention to provide a system displaying to a driver of a vehicle the relative position of a trailer hitch and trailer.

These and other objects of the invention will become apparent to one skilled in the art after reviewing the disclosure of the invention.

### SUMMARY OF THE INVENTION

The battery-powered trailer hitch video alignment system is wireless, having a video camera and transmitter relaying images of the trailer hitch to a monitor by the driver. The camera is mounted either on the towing vehicle or the trailer, whichever gives the best view of the alignment between the trailer hitch and trailer. An infrared light arrangement provides light for the camera in low-light or no-light conditions. Also, the infrared light incorporates a tape measure in the lighting system to transmit distance measurements between the towed vehicle and trailer. In this regard the infrared system provides both light and distance measurements for the benefit of the operator.

### BRIEF DESCRIPTION OF THE DRAWINGS

FIG. 1 shows an overall schematic of the system of the invention;

FIG. 2 depicts the camera mounted to the front of a towed vehicle.

### DETAILED DESCRIPTION OF THE INVENTION

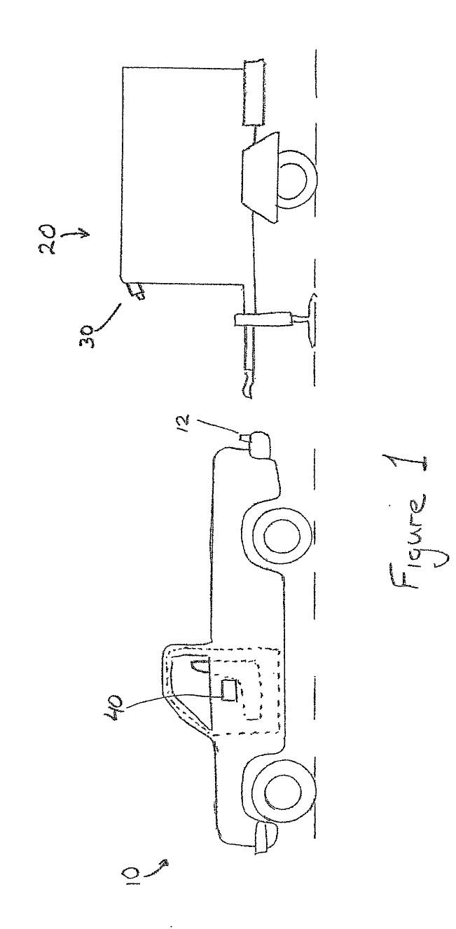

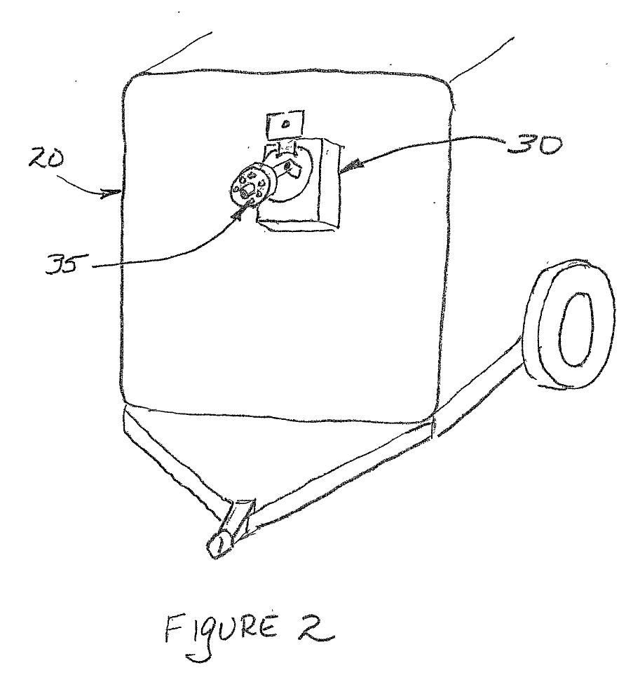

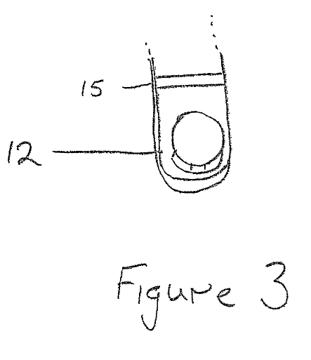

FIG. 1 shows the system for aligning a trailer hitch and a trailer. It prevents direct visual feedback of the alignment between the two. With the system, the alignment can be accomplished without a clear view out of the rear of the towing vehicle, such as an RV, and allows a single user to align a trailer hitch and trailer. As can be seen in FIG. 1, the towing vehicle 10 is provided with a trailer hitch 12. The trailer hitch couples with a trailer 20, which may be a boat trailer, a camper, horse trailer, passenger car or any other similar towed vehicle.

A camera 30 is mounted to one of the towing vehicles 10 or towed trailer 20. The camera is battery-powered and wireless and equipped with a transmitter for relaying video signals to a monitor. The use of a battery-powered, wireless video camera facilitates the installment and use of the camera. The camera may be mounted in any conventional way, including suction cup, magnetic mount, spring clamp, screws, double-sided tape, or hook and loop fasteners. Any manner is sufficient as long as it securely holds the camera in place.

The camera has an infrared lighting arrangement 35 to provide light for the camera in low-light or no-light conditions. This is particularly important as it is common to connect a towing vehicle and the trailer in the early morning hours when there is no light available before beginning a long trip. The added benefit of an infrared lighting arrangement, besides providing a clear image of the trailer hitch connection, is the use of an infrared tape measure incorporated into the camera lighting system. The infrared tape measure transmits distance measurements between the camera and the approaching towed vehicle and displays the distances on a video monitor.

A video monitor 40 is placed within the cab on the towing vehicle for easy viewing by the operator, but this connection between the video camera and monitor allows the monitor to be placed anywhere for easy viewing by the operator.

Reflective markers 15 are placed on the trailer hitch 12 to indicate fore/aft positioning to compensate for camera parallax viewing angle.

When the operator desires to connect the towing vehicle to the trailer, the camera is turned on and the camera is pointed to provide a view of the connection between the trailer hitch and trailer. While viewing the real-time images of the connection, the operator is able to maneuver the vehicle to align the trailer hitch and trailer without needing a clear view towards the rear of the towing vehicle or assistance from another person. The trailer hitch can be aligned with the towed vehicle from any angle. The distance measurement provided by the infrared tape measure facilitates the connection process.

While the invention has been described with reference to a preferred embodiment, variations and modifications would be obvious to one who is skilled in the art without departing from the scope of the invention. The invention accomplishes such variations and modifications.

What is claimed:

1. An alignment system, comprising:
a towing vehicle, said towing vehicle having a hitch;
a towed vehicle;
a camera for transmitting images, said camera mounted on one of said towed vehicle or towing vehicle;
a monitor for viewing images from said camera, and an infrared light source, said infrared light providing light for said camera in low ambient light conditions and measuring the distance between said towed vehicle and said towing vehicle.

2. The alignment system of claim 1, wherein said towed vehicle is a boat trailer.

3. The alignment system of claim 1, wherein said towed vehicle is a camper.

4. The alignment system of claim 1, wherein said camera is mounted on said towed vehicle.

5. The alignment system of claim 1, wherein a connection between said camera and said monitor is wireless.

6. The alignment system of claim 1, further comprising reflective marking on one of said hitch and towed vehicle.

7. The alignment system of claim 1, wherein said towed vehicle is a car towed by a recreational vehicle.

8. The alignment system of claim 1, wherein said vehicle is a horse trailer.
